(19) United States
(12) Patent Application Publication
(10) Pub. No.: US 2008/0272588 A1
(43) Pub. Date: Nov. 6, 2008

(54) Retaining Member of Small Size for Anchoring a Tube in a Circuit Element, and a Corresponding Circuit Element

(75) Inventors: Dominique Masson, Montgermont (FR); Phillippe Le Quere, Betton (FR)

Correspondence Address: YOUNG & THOMPSON, 209 Madison Street, Suite 500, ALEXANDRIA, VA, 22314, US

(73) Assignee: LEGRIS SA, Rennes (FR)

(21) Appl. No.: 12/093,331

(22) PCT Filed: Nov. 7, 2006
(86) PCT No.: PCT/FR06/02470

§ 371 Date: May 12, 2008

(30) Foreign Application Priority Data
Nov. 15, 2005 (FR) 0511551

(51) Int. Cl. F16L 17/00

(52) U.S. Cl. 285/10

(57) ABSTRACT

A retaining member (10) for retaining a tube in a circuit element, includes a carrier portion (10; 30) from which there extends at least one lateral anchoring member (14, 33) for anchoring the tube, the carrier portion being substantially in the form of a continuous annulus and presenting an active transverse direction (12, 36) on which the anchoring member is disposed and an inactive transverse direction (15, 37) on which the carrier portion does not have anchoring members and presents a smallest outside dimension. A circuit element including such a retaining member is also disclosed.

The present invention relates to a member for retaining a tube in an element of a circuit for transporting fluid, and to a corresponding circuit element. Such a circuit element may be a pipe, an element that emits or receives fluid such as a distributor, an actuator, a tank, a solenoid valve, a pump, . . . .

### BACKGROUND OF THE INVENTION

There exist distributors that comprise a body possessing two plane opposite side faces and defining ducts having ends that open out from the body between its two side faces and that are fitted with quick-coupling devices for coupling to respective tubes. Such distributors can be assembled on a rail along which they are clipped and positioned side by side via their side faces. In complex fluid transport circuits, a plurality of such rails can be grouped together in cabinets in order to facilitate circuit maintenance. Circuits of increasing complexity incorporate an increasing number of distributors that make it necessary to reduce the width of such distributors (as defined between the side faces of their bodies) in order to reduce the overall size of the cabinets housing them.

Unfortunately, it can be seen that the width of the body of a distributor is determined by the size of its quick-coupling device. Such a coupling device comprises a tube-retaining member that is generally constituted by an anchor washer or by a clamp. An anchor washer is an elastically deformable washer having an inside circumference subdivided into teeth for anchoring the tube. A clamp is a bushing having one end provided with a collar and an opposite end from which there extend parallel axial slots that define between them deformable arms. Each arm has one end secured to the collar and a free end provided with an inwardly directed rim. Whatever the type of retaining member, it is annular in shape in order to extend all around a zone of the tube, and it possesses an outside diameter that is much greater than that of the tube. It can thus be seen that the overall size of the quick-coupling means in a transverse direction relative to the tube is determined by the transverse dimensions of the retaining member. Unfortunately, these retaining members presently have minimum dimensions that, given their shape, cannot be made any smaller.

A member is also known from document DE-U-83 22 203 for retaining a tube in a circuit element, the retaining member having a carrier portion from which there extends at least one lateral tube-anchor means. The carrier portion is C-shaped and runs the risk of opening and weakening the action of the anchor means.

### OBJECT OF THE INVENTION

It would therefore be advantageous to have a retaining member that presents small transverse size.

### SUMMARY OF THE INVENTION

To this end, the invention provides a retaining member for retaining a tube in a circuit element, the retaining member comprising a carrier portion from which there extends at least one lateral anchoring means for anchoring the tube, the carrier portion being substantially in the form of a continuous annulus and presenting an active transverse direction on which the anchoring means is disposed and an inactive transverse direction on which the carrier portion does not have anchoring means and presents a smallest outside dimension.

As a result, in the inactive direction, the retaining member presents an outside dimension that is smaller than that needed in the active direction to enable the anchor means to act. The circuit element that is to receive such a retaining element presents, in the inactive direction of the retaining member, a transverse dimension that is relatively small. The continuity of the carrier portion enables the anchor means to be engaged on the tube firmly and effectively.

Thus, the invention also provides a fluid transport circuit element comprising a body that defines a duct and presents a smallest outside dimension in a direction that extends transversely relative to the duct, the body being fitted with a retaining member for retaining a tube in the duct, and the retaining member being mounted on the body of the circuit element in such a manner that the inactive direction of the retaining member is parallel to the smallest-dimension direction of the body of the circuit element.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a diagrammatic perspective view of a circuit element in accordance with a first embodiment of the invention;

FIG. 2 is an exploded view of said circuit element;

FIG. 3 is a cutaway fragmentary perspective view of said circuit element;

FIG. 4 is a perspective view of the retaining member of said circuit element;

FIG. 5 is a perspective view of a circuit element in accordance with a second embodiment of the invention;

FIG. 6 is a cutaway and exploded perspective view of said element;

FIG. 7 is a perspective view of the retaining member of said circuit element;

FIG. 8 is a plan view of a variant of the retaining member of the second embodiment of the circuit element; and

FIG. 9 is a longitudinal section view showing a variant of the retaining member of the second embodiment circuit element.

### DETAILED DESCRIPTION OF THE INVENTION

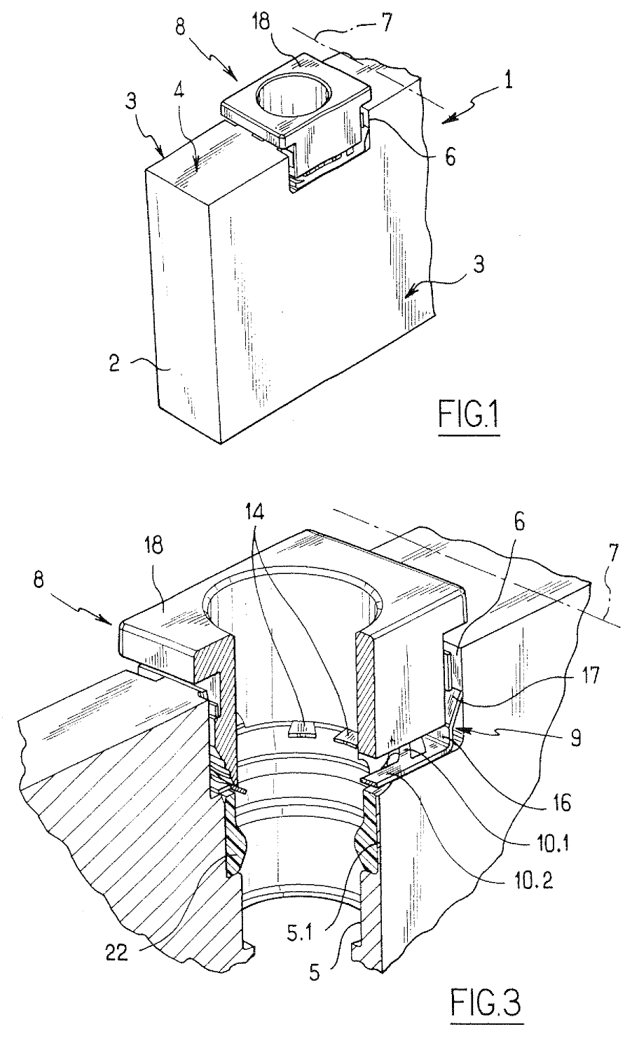

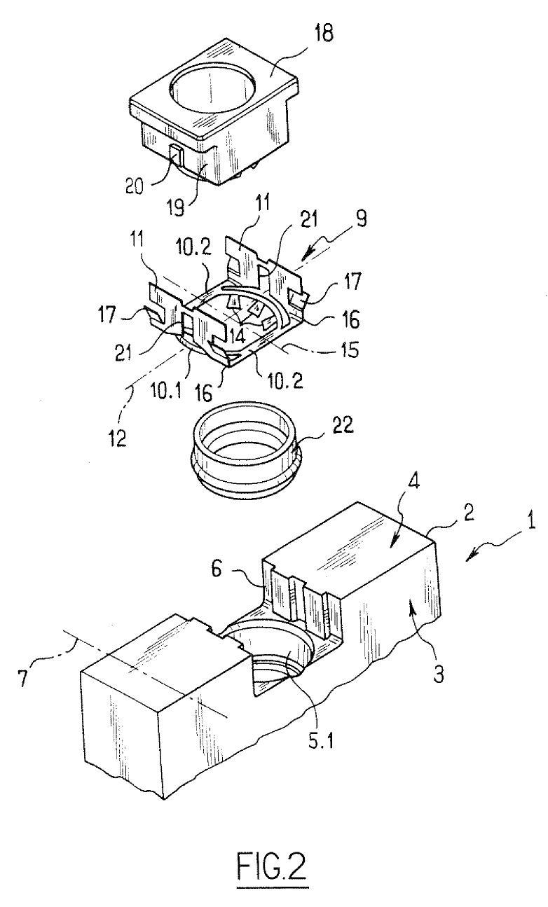

FIGS. 1 to 3 show a circuit element given overall reference 1, such as a distributor, comprising a body 2 that is substantially in the shape of a rectangular parallelepiped. The body 2 has two plane, parallel side faces 3, and a top face 4. The body 2 defines a duct 5 that opens out perpendicularly in a notch 6 formed in the body 2 from its top face 4. The side faces 3 are spaced apart by a distance (as measured in the direction 7 constituting the width of the circuit element 1) that forms the smallest dimension of the body 2 transversely relative to the duct 5.

The notch 6 receives a device given overall reference 8 for quick-coupling a tube (not shown in the figures) to the duct 5.

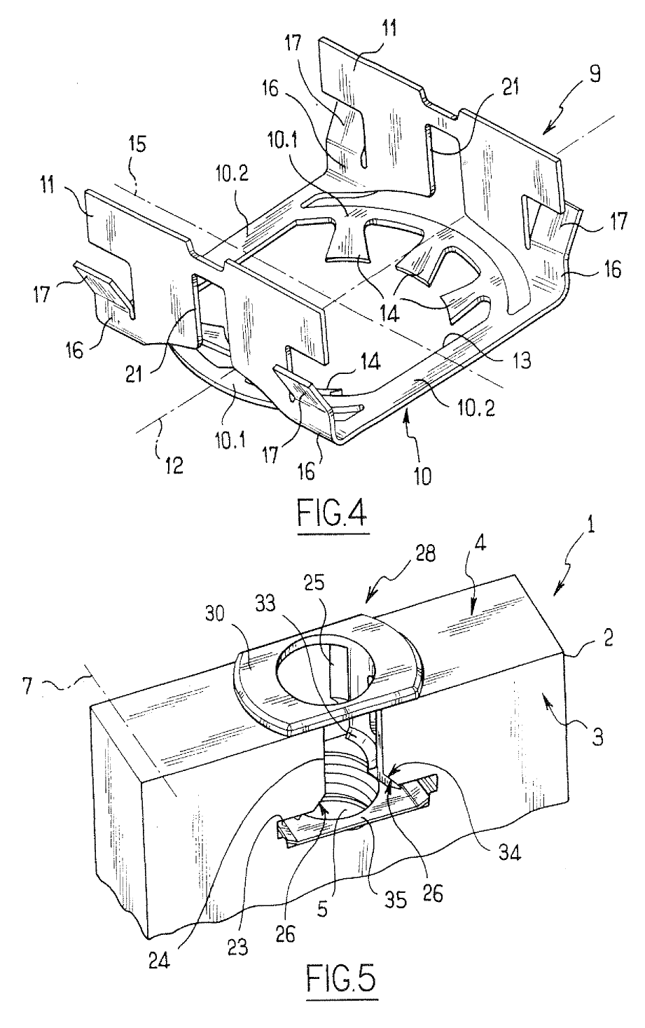

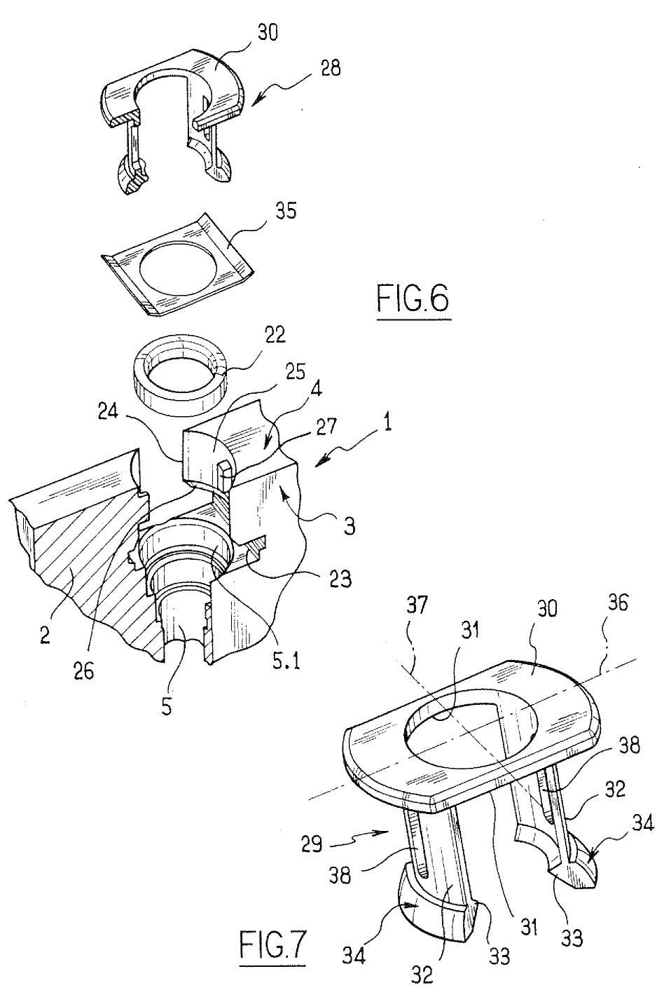

With reference also to FIG. 4, the coupling device 8 comprises a keeper given overall reference 9, made from stamped sheet metal possessing a central web 10 from which there extend perpendicularly two opposite side flanges 11. The central web 10 comprises two circularly arcuate portions 10.1 that are opposite each other in a direction 12 and two parallel rectilinear portions 10.2 uniting the circularly arcuate portions 10.1. The portions 10.1 and 10.2 define an opening 13 having teeth 14 projecting therein from the circularly arcuate portions 10.1. The central web 10 thus forms a portion carrying the teeth 14 and presents a cross-section of continuous annular shape. The teeth 14 are arranged to bite into the outside surface of the tube that is to be coupled to the duct 5. The continuity of the central web 10, which thus resists deformation relatively strongly, enables the teeth 14 to be pressed hard against the wall of the tube, thereby facilitating penetration of the teeth 14 therein. The teeth 14 are disposed in two diametrically opposite groups bunched together around the direction 12 to define a through section smaller than the section of the tube. The direction 12 is referred to as the active anchoring direction. The rectilinear portions 10.2 are spaced apart by a distance in the direction 15 that is substantially equal to the outside diameter of the tube, whereas the circularly arcuate portions are spaced apart by a distance that is slightly smaller than the sum of the outside diameter of the tube plus twice the length of the teeth 14. The keeper 9 presents a smaller outside dimension in the inactive anchoring direction 15. This smaller outside dimension is substantially equal to the thickness defined between the side faces 3.

The side flanges 11 are connected to the central web 10 via curved tabs 16 that extend in line with the rectilinear portions 10.2 so as to avoid interfering with deformation of the circularly arcuate portions 10.1 while a tube is being introduced. Anchor teeth 17 are cut out in the side flanges 11 to project outwards therefrom so as to bite the flanks of the notch 6 so as to ensure that the keeper 9 is retained in the notch 6 in such a manner that the central web 10 of the keeper 9 is located at the outlet of the duct 5 in the notch 6.

The keeper 9 slidably receives a pusher 18 defining a channel for receiving the tube for coupling to the duct 5 and possessing two opposite side faces 19 for slidably co-operating with the side flanges 11 of the keeper. A stud 20 projects from each of the side faces 19 of the pusher 18 to be slidably received in a slot 21 formed in the corresponding side flange 11. The slot 21 extends parallel to the central axis of the opening 13 so as to retain the pusher 18 on the keeper 9 and guide the sliding of the pusher 18 between a connection position in which the pusher 18 bears lightly against the teeth 14 (the teeth 14 tending to urge the pusher 18 into the connection position) and a disconnection position in which the pusher 18 is pushed in so as to lift the teeth 14 and thereby increase the through section they define.

The coupling device also includes an annular sealing element 22 that possesses an inside diameter slightly smaller than the outside diameter of the tube and that is received in an end setback 5.1 in the duct 5. The central portion 10 holds the annular sealing element 22 in the end setback 5.1.

When the tube is engaged in the pusher 18 while it is in the connection position, and then in the opening 13, the sealing element 22, and then the duct 5, the teeth 14 bite into the outside surface of the tube, and the central web 10 forms a member for retaining the tube in the duct 5.

To disconnect the tube, the pusher 18 is pushed into the disconnection position, thereby moving the free ends of the teeth 14 to disengage them from the tube so that the tube can be extracted.

Elements that are identical or analogous to those described above are given the same numerical references in the description below of the second embodiment.

In this embodiment, the end setback 5.1 receiving the annular sealing element 22 opens out into a first housing 23 that in turn opens out to the top face 4 via a second housing 24.

The housing 24 is defined by two walls 25 in the form of portions of a cylinder that are connected to the housing 23 via coupling surface 26 forming portions of a truncated cone. A stud 27 projects from each of the walls 25. The housing 24 slidably receives a retaining member given overall reference 28.

In this embodiment, the retaining member 28 comprises a tubular portion 29, of outside diameter slightly smaller than the diameter of the walls 25, having a first end projecting out from the body 2 and a second end projecting into the housing 23. The first end has a collar 30 of cross-section that is substantially in the shape of a continuous annulus. Two wide gaps 31 extend axially in the tubular portion from the second end to form two diametrically opposite arms 32, each having one end connected to the collar 30 and an opposite end that is free. The collar 30 forms a portion that carries the arms 32. The free end is provided with an inwardly-projecting rim 33 and with an outer frustoconical surface 34 that tapers towards the collar 30 to co-operate with the coupling surfaces 26. The rims 33 define a through section that is slightly smaller than that of the tube. In each arm 32 there is formed an axial slot for receiving the corresponding stud 27. The width of the arms 32 is less than the thickness of the body 2. The arms 32 are disposed on the transverse direction 36 that forms the active anchoring direction of the retaining member 28, the inactive anchoring direction 37 being the transverse direction that is perpendicular to the active anchoring direction 36. It should be observed that the collar 30 possesses two opposite flats perpendicular to the inactive anchoring direction 37 such that the collar 30 is shorter in the inactive anchoring direction 36.

The housing 23 also opens out into the side faces 3 and receives a keeper 35 in the form of metal sheets pierced by an opening for passing the tube, serving to retain the annular sealing element 22 in the end setback 5.1.

When the tube is engaged in the retaining member 28 while in the connection position, and then in the keeper 35, the sealing element 22, and then the duct 5, the rims 33 bite into the outside surface of the tube. When the circuit in which the circuit element 1 is incorporated is put under pressure, the tube moves back a little, taking the retaining member 28 with it. The outer frustoconical surfaces 24 slide over the coupling surface 26, thereby urging the arms 32 towards each other and increasing the clamping exerted thereby on the tube.

To disconnect the tube, the retaining member 28 is pushed in by pressing on the collar 30 in such a manner that the arms cease clamping the tube. The tube can then be extracted.

Naturally, the invention is not limited to the embodiments described and variant embodiments can be provided without going beyond the ambit of the invention as defined by the claims.

In the first embodiments the teeth may themselves be deformable, or they may behave like rigid blades capable of tilting about the circularly arcuate portions 10.1, providing the circularly arcuate portions 10.1 are sufficiently flexible. The teeth may also be secured to the flanges 11 or more generally to a rigid portion. The teeth may also be of some other shape, e.g. defined between side edges that are parallel or that converge towards their free ends.

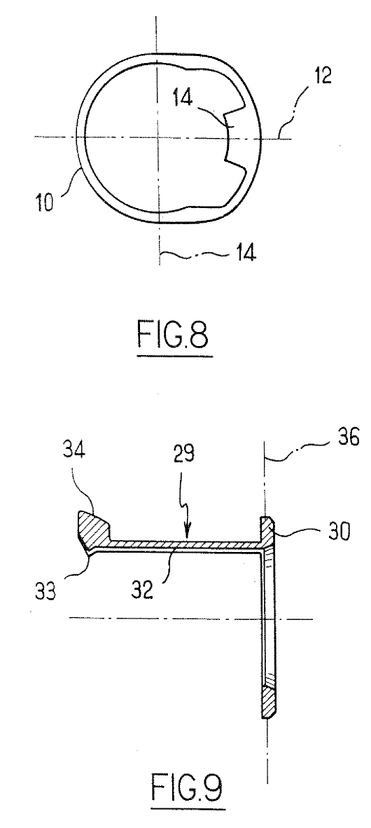

In a variant, the number of anchoring means may be different. The washer need have only one tooth (see FIG. 8), and similarly the tubular retaining member need have only one arm (see FIG. 9).

1-5. (canceled)

6. A retaining member (10, 28) for retaining a tube in a circuit element, the retaining member comprising a carrier portion (10; 30) from which there extends at least one lateral anchoring means (14, 33) for anchoring the tube, wherein the carrier portion is substantially in the form of a continuous annulus and presents an active transverse direction (12, 36) on which the anchoring means is disposed and an inactive transverse direction (15, 37) on which the carrier portion does not have anchoring means and presents a smallest outside dimension.

7. A retaining member (10) according to claim 6, including a plurality of anchoring means (14) concentrated around the active direction.

8. A retaining member (10) according to claim 6, in which the carrier portion (10) has an inside circumference from which there projects at least one tooth (14) forming the anchoring means.

9. A retaining member (28) according to claim 6, of substantially tubular shape, comprising a collar (30) forming the carrier portion and pierced by a tube-passing orifice, and at least one arm (32) projecting axially from the collar and possessing a free end provided with a rim (33) forming the anchoring means.

10. A fluid transport circuit element (1) comprising a body (2) that defines a duct (5) and presents a smallest outside dimension in a direction (7) that extends transversely relative to the duct, the body being fitted with a retaining member (10, 28) for retaining a tube in the duct, wherein the retaining member is in accordance with claim 6 and is mounted on the body of the circuit element in such a manner that the inactive direction (15, 37) of the retaining member is parallel to the smallest-dimension direction of the body of the circuit element.
